(19) United States
(12) Patent Application Publication
(10) Pub. No.: US 2008/0044347 A1
(43) Pub. Date: Feb. 21, 2008

(54) Onboard reforming of fuel and production of hydrogen

(76) Inventors: Subir Roychoudhury, Madison, CT (US); Dennis Walsh, Richboro, PA (US); Richard Mastanduno, Milford, CT (US)

Correspondence Address: Robert L. Rispoli;Precision Combustion, Inc., 410 Sackett Point Road, North Haven, CT, 06473, US

(21) Appl. No.: 11/707,488

(22) Filed: Feb. 16, 2007

Related U.S. Application Data
(60) Provisional application No. 60/774,830, filed on Feb. 16, 2006.

(51) Int. Cl. C01B 3/50

(52) U.S. Cl. 423/658.3

(57) ABSTRACT

The invention provides a method for the production of hydrogen comprising providing a first stream comprising fuel, providing a second stream comprising a partial exhaust stream from an internal combustion engine wherein the exhaust stream further comprises steam, providing a third stream of air, passing the first, second, and third streams through a catalytic reforming reactor, the reactor further comprising a supported precious metal catalyst, and producing reactant products comprising hydrogen.

### CROSS-REFERENCE

This application claims the benefit of U.S. Provisional Application No. 60/774,830 filed Feb. 16, 2006.

### FIELD OF THE INVENTION

The present invention is generally directed to a method for reforming fuel employing a CPOX (Catalytic Partial Oxidation) reactor. More particularly, the present invention is directed toward employing an ATR (Autothermal Reformer) reactor and producing hydrogen. One embodiment of the system permits the production of hydrogen onboard an operating vehicle.

### BACKGROUND OF THE INVENTION

A CPOX reactor consists of a catalytic element enclosed in housing. The reactor is fed by a fuel stream and an oxidizer stream (collectively called the reactants), producing a product stream comprised of products of chemical partial oxidation reactions. Typical fuel streams include hydrocarbon liquid or gaseous fuels, and typically air is used as the oxidizer. The reactor construction and reactant flow rates are chosen to produce the desired mix of products. Designs for these reactors are well known in the art.

An ATR reactor also produces partial oxidation reactants in a similar manner, with the addition of steam to the reactants. The advantages of ATR reactors are well known, but the major disadvantage for certain applications is the requirement for a water supply to produce the required steam. This disadvantage makes the ATR approach undesirable in mobile applications where a water supply would require additional undesirable weight for water recovery, a storage tank, protection from freezing, and other logistic requirements.

The invention seeks to overcome the need for a water supply and its disadvantages while simultaneously allowing the advantages of an ATR.

### SUMMARY OF THE INVENTION

A device according to the present invention utilizes the exhaust from an internal combustion engine as all or a portion of the oxidizer stream. The device advantageously utilizes the water formed in the exhaust as a natural product of combustion in the engine. The use of the exhaust for the oxidizer produces the unexpected effect of promoting the production of desirable reaction products typical of ATR operation due to the addition of the water normally produced by the engine combustion process without the requirement of a separate water supply.

Thermodynamics of the ATR Approach:

Hydrocarbons may be reformed to H₂-containing products through steam reforming (1) or partial oxidation (2).
CHₙ+H₂O→CO+(n/2+1)H₂ΔH>0 (1) steam reforming
CHₙ+½O₂→CO+n/2H₂ΔH<0 (2) partial oxidation

The steam reforming reaction is endothermic and requires an external heat supply. In contrast, traditional non-catalytic partial oxidation of liquid hydrocarbons proceed through a complete oxidation step, such that very high temperatures are reached on the front of the reactor. For improved efficiency and control of the process it is desirable to operate a primary reformer in the autothermal regime through combining steam reforming with catalytic partial oxidation in one reactor.

In an overall reforming process—independent of the particular reforming strategy—hydrocarbons are reacted with a certain amount of water and oxygen to produce molecular hydrogen, CO and CO₂. CO can be converted to CO₂ and an overall reforming equation (3) can be used:
CHₙ+2(1−x)H₂O+xO₂→CO₂+(n/2+2−2x)H₂ (3) overall reforming process

Stoichiometry of equation 3 suggests that increasing the amount of oxygen leads to decreasing hydrogen yield, while removing oxygen makes the process endothermic (i.e. dependent on the external heat import). Maximum hydrogen yield from a self sustaining hydrocarbon reformation process would be achieved when coefficients in an ideal reformer equation 3 are adjusted to make the net enthalpy of the process equal zero (DH=0). The condition of DH=0 allows to solve for x and find the coefficients in the equation 4.

The ideal stoichiometry (H₂O:C and O₂:C ratios) would vary for different hydrocarbons. For long chain alkanes, isooctane can be used as an example. For isooctane the ideal thermally neutral reforming equation will have the form:
C₈H₁₈(l)+10H₂O(l)+3O₂→8CO₂+19H₂ (4)

Note, that both hydrocarbon and water are assumed as liquids in equation (4). This accounts for heat of vaporization of these two components, which has to be considered a part of the reformation process.

Equation 4 provides that a 100% thermally efficient reformation process yields 19 moles of H₂ per one mole of isooctane and can be used to estimate the efficiency of real fuel reformers based on the measured hydrogen yield. In practice the reforming process is divided into several steps, e.g. oxidation reactions followed by steam reforming, water gas shift reactions and CO clean up. Comparing hydrogen yield at each step with the maximum yield given by equation 4 allows estimating efficiency loss associated with each step and provides bases for comparing different reforming strategies.

### BRIEF DESCRIPTION OF THE DRAWINGS

FIG. 1 depicts a diagrammatic representation of a diesel fuel reforming system in accordance with the present invention.

FIG. 2 depicts graphically the equilibrium molar yield per mole of n-dodecane in a partial oxidation reaction.

FIG. 3 depicts graphically the equilibrium molar yield per mole of n-dodecane in oxidative steam reforming.

FIG. 4 depicts a schematic of the rig designed for testing of the logistic fuel ATR reactor.

FIG. 5 provides a tabular representation of tests performed embodying the current invention.

FIG. 6 depicts graphically the production of hydrogen in dry and steam assisted reforming in order to demonstrate the innovation of the present invention.

FIG. 7 depicts a diagrammatic representation of a particular embodiment of a diesel fuel reforming system in accordance with the present invention.

### DETAILED DESCRIPTION OF THE INVENTION

A fuel reforming system 10 according to the present invention is shown in FIG. 1. Diesel fuel 12 is passed into a reformer 14. A portion 16 of diesel exhaust stream 18 is bled from the diesel exhaust stream 18 and passed into the reformer 14. The remainder of diesel exhaust stream 18 bypasses reformer 14. A supplemental air source 20 may be added in order to provide the required total oxidizer flow. The reformate or reformer 14 exit stream 22 contains Hydrogen (H₂).

In one preferred embodiment of the present invention, a thermodynamic examination of ideal partial oxidation conditions desirable for efficient JP-8 reforming, which is the first step of the proposed approach, and is the key reaction for maximized efficiency, is presented here. To estimate the achievable conversion levels and H₂ yield in partial oxidation of JP-8, calculations of thermodynamic equilibrium were performed using STANJAN. This program allows calculating the thermodynamic equilibrium conditions (temperature, pressure and mixture composition) for mixtures with given inlet parameters. In our calculations n-dodecane, which is usually considered a surrogate for a JP-8 fuel, was used as a fuel to model JP-8 reforming process.

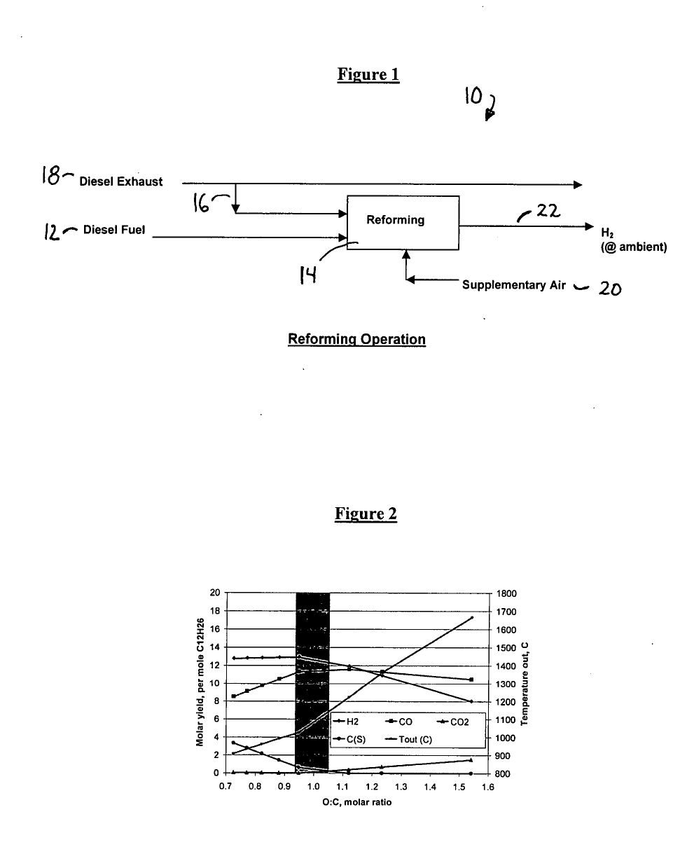

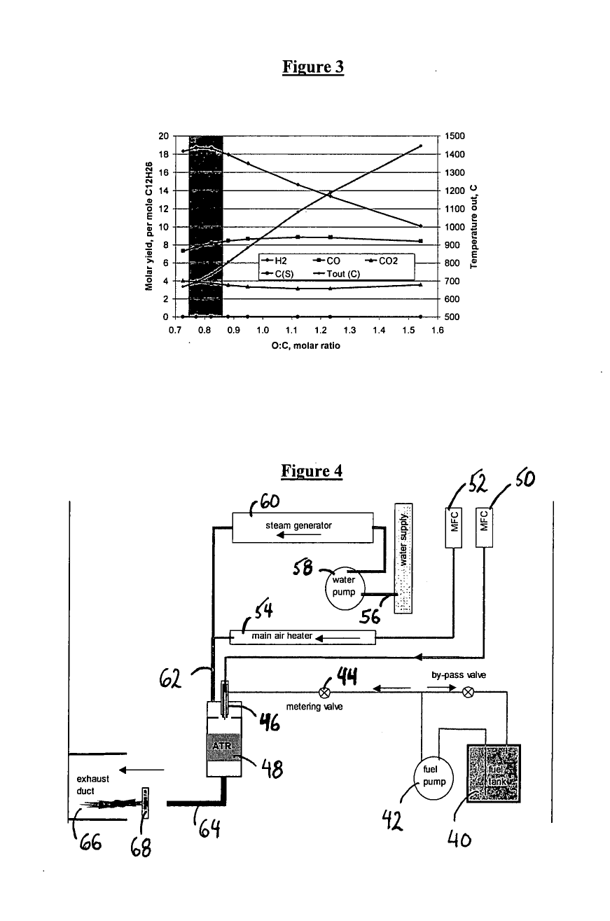

In the case of CPOX analysis, a mixture of n-dodecane and air with variable O:C ratio at fixed inlet temperature of 400° C. was used as the initial gas mixture. Adiabatic constrains (constant pressure and enthalpy) were used to calculate the composition temperature of the corresponding equilibrium mixture. The results of these calculations are presented in FIG. 2. Thermodynamic predictions of the partial oxidation process are within the material limits of commonly available high temperature alloys used to support the catalyst. The results of this analysis suggest that the CPOX process should be conducted at the air to fuel ratio of about O:C=1 (highlighted operating window in the plot) where H₂ and CO selectivity are maximized with minimized carbon and CO₂ formation and optimal reactor temperature.

In order to maximize the H₂ output and design a reforming reaction operating as close to thermally-neutral as realistically possible, some water addition to the reactor inlet will be necessary. This also reduces the maximum surface temperature without compromising selectivity or conversion. By varying the amount of water addition, the reformate temperature and composition can be adjusted to closely match the requirements of a downstream fuel cell or reactor system. Accordingly, a heat exchanger size can be chosen and efficiency maximized.

To estimate the achievable conversion levels and H₂ yield for the oxidative steam reforming of JP-8, and to compare it to CPOX results, mixtures n-dodecane with steam and air were used. The results of this analysis are presented in FIG. 3. In this case the steam to fuel ratio was fixed at H₂O:C=1, while the air to fuel ratio was varied in the same range as in the CPOX analysis presented in FIG. 2.

The initial temperature of the mixture (which is equivalent to the inlet temperature to the reactor) was 400° C., same as in the CPOX analysis. The results of the thermodynamic calculations show that addition of steam to the fuel/air mixture significantly increases hydrogen concentration in the product mixture, while decreasing CO concentration and temperature. Also carbon formation (C(S) line in the plot) at lower O:C ratios is suppressed by steam addition. For the oxidative steam reforming process, the optimum operation window shifts to lower air to fuel ratios (O:C˜0.8 for H₂O:C=1) as compared to dry partial oxidation process. This can result in higher efficiency of the reformer. Also lower process temperatures are beneficial for the catalyst durability.

ATR Rig Description:

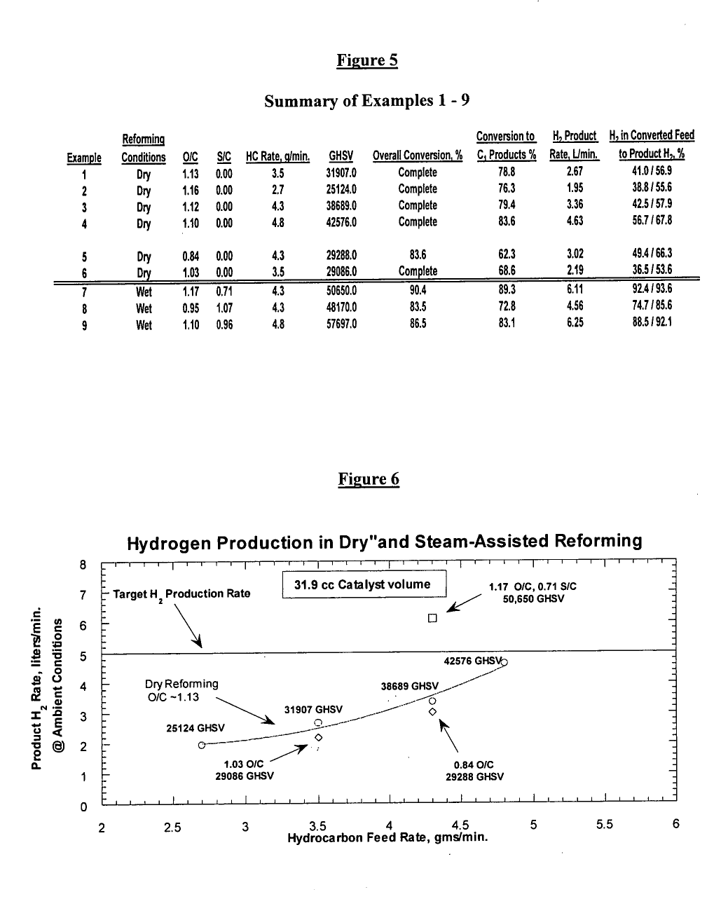

A schematic of the rig designed for testing of the logistic fuel ATR reactor is provided in FIG. 4. Fuel 40 is pressurized by a fuel pump 42 and metered through a Max-meter gauge 44. Fuel 40 is then sprayed directly into the ID plenum 46 of the radial flow catalyst bed 48 using a commercially available air-assist spray nozzle. Fuel atomization was visually inspected by running fuel and air through the nozzle without the catalytic reactor attached to the system. The nozzle provided uniform spray pattern and good fuel atomization.

Compressed air was supplied to the rig and was metered by Mass Flow Controllers 50, 52. A small and constant fraction of the air flow metered by Mass Flow Controller 50 was directed to the spray nozzle for fuel atomization while the remaining portion was directed around the nozzle and into the ID plenum of the catalyst bed. The air was mixed with the atomized fuel spray prior to entering the catalyst bed. The air flow metered by Mass Flow Controller 52 was passed into main air heater 54. Ambient air without external pre-heating was used in these tests.

Water flow 56 was metered by a calibrated piston pump 58 and was passed through an electrically heated vaporizer 60 prior to mixing with the air flow metered by Mass Flow Controller 52. Fuel/air/steam mixture 62 entered the catalyst bed 48 where the auto-thermal reaction takes place producing H₂ and CO. The reformate stream 64 was then vented to an exhaust duct 66. A catalyzed screen 68 installed at the duct entrance ignited the CO and H₂ in the exhaust stream, flaring the reformate prior to release into the venting ducts.

Reforming data was obtained in the ATR rig depicted in FIG. 4 (31.9 cc catalyst volume) using low sulfur diesel as the feed. The low sulfur diesel fuel is commercially available from Chevron Phillips Chemical Company as Diesel 2007 Emission Cert Fuel.

The catalyst was a Microlith™ based Rh/alumina formulation. The Microlith™ catalyst substrate is commercially available from Precision Combustion, Inc. Tests were performed at ambient pressure and gas hourly space velocities (GHSV) ranging from ˜25,000 to ˜58,000 (Space velocity could be much higher. The value here represents only the examples described below). GHSV is defined as the volumetric flow rate per hour at ambient conditions of all feed components divided by the catalyst volume. (Since hydrocarbon—and water which was used in selected tests—are liquids at ambient conditions, for purposes of the GHSV calculation their pseudo-gaseous volumetric flow rates are employed. These volumetric rates are calculated based on component molar flow rates were they to exist as vapors at the conditions upon which the GHSV is based.). The following examples and their discussion serve to illustrate the innovation.

### EXAMPLE 1

Low sulfur diesel fuel was reformed under dry conditions (no water co-feed) at 3.5 g/min. and 1.13 O/C at 31,907 GHSV. Results are shown in the FIG. 5.

### EXAMPLE 2

Low sulfur diesel fuel was reformed under dry conditions (no water co-feed) at 2.7 g/min. and 1.16 O/C at 25,124 GHSV. Results are shown in the FIG. 5.

### EXAMPLE 3

Low sulfur diesel fuel was reformed under dry conditions (no water co-feed) at 4.3 g/min. and 1.12 O/C at 38,689 GHSV. Results are shown in the FIG. 5.

### EXAMPLE 4

Low sulfur diesel fuel was reformed under dry conditions (no water co-feed) at 4.8 g/min. and 1.10 O/C at 42,576 GHSV. Results are shown in the FIG. 5.

### EXAMPLE 5

Low sulfur diesel fuel was reformed under dry conditions (no water co-feed) at 4.3 g/min. and 0.84 O/C at 29,288 GHSV. Results are shown in the FIG. 5.

### EXAMPLE 6

Low sulfur diesel fuel was reformed under dry conditions (no water co-feed) at 3.5 g/min. and 1.03 O/C at 29,086 GHSV. Results are shown in the FIG. 5.

### EXAMPLE 7

Low sulfur diesel fuel was reformed under wet conditions (with water co-feed) at 4.3 g/min. and 1.17 O/C, 0.71 S/C at 50,650 GHSV. Results are shown in the FIG. 5.

### EXAMPLE 8

Low sulfur diesel fuel was reformed under wet conditions (with water co-feed) at 4.3 g/min. and 0.95 O/C, 1.07 S/C at 48,170 GHSV. Results are shown in the FIG. 5.

### EXAMPLE 9

Low sulfur diesel fuel was reformed under wet conditions (with water co-feed) at 4.8 g/min. and 1.10 O/C, 0.96 S/C at 57,697 GHSV. Results are shown in the FIG. 5.

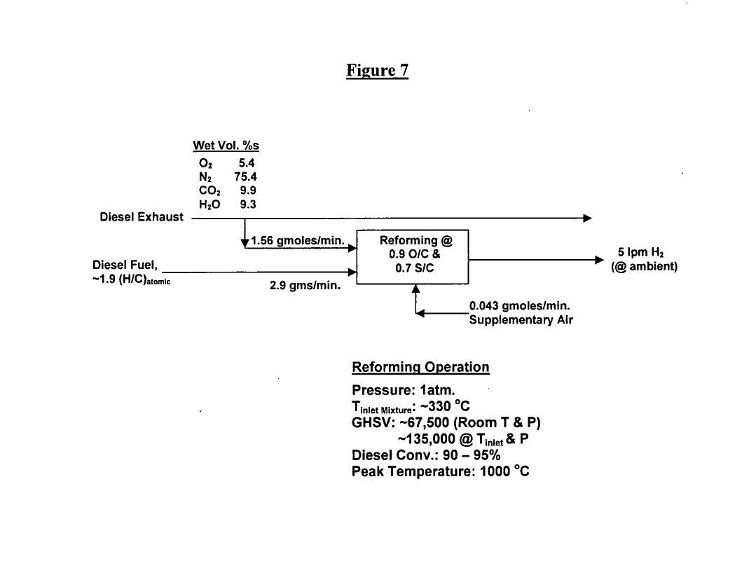

Referring to Examples 1-4 above, the curve in FIG. 6 corresponds to the dry reforming (no H₂O co-feed) results obtained at ˜1.13 O/C (±0.03 O/C). Choosing for illustration purposes a target H₂ production rate of 5 liters/minute, a modest extrapolation of the curve indicates that this can be achieved at a hydrocarbon feed rate of ˜5.1 gm/min (corresponding to 45,000-50,000 GHSV). 5.1 gm./min is ˜1.7× greater than the theoretical minimum required with ideal CPOX.

The plot illustrates that increasing the hydrocarbon feed rate at approximately constant O/C increases the GHSV. Yet, over the entire operating range, total conversion to all non-diesel feed products was complete. Likewise, conversion to C₁ products (CO, CO₂, CH₄) showed no systematic variations around an average value of ˜79-80%. The difference between the total conversion and C₁ conversion is the result of the production of C₂+ hydrocarbon products. The ability to maintain high conversion as space velocity is increased indicates excess catalyst activity. Therefore, the catalyst bed could be smaller and, therefore, the space velocity even higher. The percentage of hydrogen in the converted diesel fuel which becomes H₂ at the target production rate is estimated to be ˜60% based on total conversion and ˜70% based on conversion to C₁ products.

Examples 5 and 6 illustrate the effect of O/C. These results were obtained at somewhat lower O/C ratios (diamond points in FIG. 6). Conversion to C₁ products is ˜10-15% (on an absolute basis) lower than those at 1.13 O/C and H₂ yields are reduced.

In Examples 7-9, limited testing was performed at low S/C (≦˜1). Illustrating the potential impact of low S/C are the results obtained in Example 7 at 0.71 S/C and 1.17 O/C (this O/C is slightly higher than that characterizing the dry reforming curve). As the square point in FIG. 6 shows, due to steam flow, GHSV is higher than that estimated for dry reforming at a comparable hydrocarbon feed rate. Total conversion drops vs. dry reforming (˜90% vs.˜100%), but the differential between total conversion and C₁ based conversion decreases with steam present due to reduced production of C₂+ hydrocarbon products (89% vs. 75-80%). The H₂ production rate is >2 l/min. higher than dry reforming. Although steam conversion is contributing to H₂ in the product, arbitrarily relating the H₂ yield solely to the hydrogen in the converted diesel fuel feed yields ˜92 and 94% on total and C₁ conversion bases, respectively.

The location of the lower O/C points (diamonds) suggests a family of dry reforming curves, each at an approximately constant O/C falling correspondingly below the curve in FIG. 6 for O/C<1.13 and above it at O/C>1.13. This family of curves would exist only within certain bounds, however. This is because, in the lower O/C cases, it would be expected that with declining O/C eventual coking would become severe and H₂ production would fall. Likewise, at increasing O/C, CO₂ and water production would begin to dominate with an attendant decline in H₂ production. Nevertheless, it may reasonably be expected from the above examples that, at modestly higher O/C ratios (e.g. the 1.2), a given target H₂ production rate could be achieved at a reduced hydrocarbon feed rate.

Likewise, given the location of the S/C point (square) on the graph and the data from Examples 8 and 9 (not plotted), a family of steam assisted reforming curves may reasonably be inferred, each at fixed O/C and S/C and located above the corresponding dry reforming curve at the same O/C. Because of increased H₂ production in the presence of steam, a given target H₂ production rate could be achieved at a reduced hydrocarbon feed rate.

The decision to augment dry reforming with some steam addition would depend upon the interplay between the desire to reduce the hydrocarbon feed rate and any application specific constraints. As noted above, the use of some steam may also be desirable for maximizing hydrocarbon conversion and to moderate and manage any potential propensity for coke formation under dry reforming conditions (a tendency suggested by the increasing gap between overall conversion and conversion to C₁ products with declining O/C).

The use of water can be burdensome, however, especially in on-board reforming of hydrocarbon fuels in transportation applications. Such applications seek to reform part or all of the hydrocarbon fuel as a means of enhancing the performance of internal combustion engines, particularly with regard to emissions reductions. The use of water in such instances requires either carrying water on-board in a separate tank or condensing water from the exhaust which requires extensive heat exchange equipment.

The present innovation uses a part of the engine exhaust—without condensing the water—as the source of all water and part of the oxidizer in order to effectively reform the liquid fuel. This eliminates the need for a separate water tank and/or condensation capabilities. Example 10 below illustrates the concept.

### EXAMPLE 10

As described by John B. Heywood in “Internal Combustion Engine Fundamentals,” the operation of a typical 4 stroke compression ignition engine, noting that, at full load, the mass of fuel injected is ˜5% of the mass of air in the cylinder. This corresponds to an equivalence ratio of ˜0.7 which is typical of the diesel combustion process which operates on the lean side of stoichiometric (φ≦0.8). Because of this lean operation, Heywood notes that combustion is essentially complete and therefore diesel exhaust gas composition can be straightforwardly represented as a function of equivalence ratio.

The exhaust gas information presented by Heywood, in conjunction with the data in FIG. 5 and FIG. 6, can be used to estimate the amount of diesel fuel feed and diesel exhaust that must be delivered to the reformer at a particular O/C and S/C. FIG. 7 presents estimates for the resultant stream rates and compositions for reforming at 0.9 O/C and 0.7 S/C to provide the illustrative H₂ production rate of 5 liters/minute. The hydrocarbon feed rate at these feed ratios was estimated using interpolation and extrapolation of the experimentally observed O/C and S/C dependencies discussed in Examples 1-9. At the O/C illustrated in FIG. 7, the oxygen content of the diesel exhaust is not sufficient to satisfy the requirement; consequently, supplementary air is supplied to the reformer to make up the difference.

While the present invention has been described in considerable detail with reference to the reforming of diesel fuel utilizing an ATR reactor, other geometric configurations exhibiting the characteristics taught herein are contemplated. Therefore, the spirit and scope of the invention should not be limited to the description of the preferred embodiments described herein.

We claim:

1. A method for reforming fuel comprising:
a) providing a first stream comprising fuel;
b) providing a second stream comprising a partial exhaust stream from an internal combustion engine; and
c) passing the first and second stream through a catalytic reforming reactor.

2. The method of claim 1 wherein the catalytic reforming reactor is an autothermal reactor.

3. The method of claim 2 further comprising the additional step of providing a third stream of air and passing it through the catalytic reforming reactor.

4. The method of claim 2 wherein the catalytic reforming reactor comprises a supported precious metal catalyst.

5. The method of claim 4 wherein the supported precious metal catalyst comprises Rhodium and Alumina.

6. The method of claim 5 wherein the catalyst substrate comprises an ultra-short channel length monolith substrate.

7. The method of claim 1 wherein the fuel comprises diesel fuel.

8. A method for the production of hydrogen comprising:
a) providing a first stream comprising fuel;
b) providing a second stream comprising a partial exhaust stream from an internal combustion engine wherein the exhaust stream further comprises steam;
c) providing a third stream of air;
d) passing the first, second, and third streams through a catalytic reforming reactor, the reactor further comprising a supported precious metal catalyst; and
e) producing reactant products comprising hydrogen.

9. The method of claim 8 wherein the supported precious metal catalyst comprises Rhodium and Alumina.

10. The method of claim 9 wherein the catalyst substrate comprises an ultra-short channel length monolith substrate.
